(19) United States
(12) Patent Application Publication
(10) Pub. No.: US 2024/0135066 A1
(43) Pub. Date: Apr. 25, 2024

(54) A Method for the Simulation of an Energy-Filtered Ion Implantation (EFII)

(71) Applicant: mi2-factory GmbH, Jena (DE)

(72) Inventors: Florian KRIPPENDORF, Jena (DE); Constantin CSATO, Jena (DE)

(21) Appl. No.: 18/547,874

(22) PCT Filed: Feb. 23, 2022
(86) PCT No.: PCT/EP2022/054573

§ 371 Date: Aug. 24, 2023

(30) Foreign Application Priority Data
Aug. 23, 2021 (LU) LU 102558

(51) Int. Cl. G06F 30/20; G06F 111/08; H01J 37/317

(52) U.S. Cl. CPC G06F 30/20; H01J 37/3171; G06F 2111/08; H01J 2237/057; H01J 2237/31705

(57) ABSTRACT

A computer-implemented method for the simulation of an energy-filtered ion implantation (EFII) is provided, including: Determining at least one part of an energy filter; determining at least one part of an ion beam source; determining a simulation area in a substrate: implementing the determined at least one part of the energy filter, the determined at least one part of the ion beam source, the determined simulation area in the substrate; Determining a minimum distance between the implemented at least one part of the energy filter and the implemented substrate for enabling a desired degree of a lateral homogenization of the energy distribution in a doping depth profile of the implemented substrate; determining a maximum expected scattering angle of the energy filter by simulating an energy-angle spectrum for the energy filter; and defining a total simulation volume.

### CROSS-REFERENCE TO RELATED APPLICATIONS

This application is a U.S. National Stage Application of, and claims the benefit of, International PCT Application Number PCT/EP2022/054400, filed on 10 Feb. 22, 2022, which claims the benefit of and priority to Luxembourg Patent Application LU 102558, filed on 24 Feb. 2021. The entire disclosure of Luxembourg Patent Application LU 102558 is hereby incorporated by reference.

### TECHNICAL FIELD

The disclosure relates to computer-implemented methods for the simulation of an energy-filtered ion implantation (EFII).

### BACKGROUND

In commercially oriented micro technical production processes, masked and/or non-masked doping elements are to be introduced by means of ion implantation into materials, such as semiconductors (silicon, silicon carbide, gallium nitride) or optical materials (glass, LiNbO3, PMMA), with predefined depth profiles in the depth range from a few nanometers up to a plurality of 10 micrometers.

Ion implantation is a method to achieve doping or production of defect profiles in a material, such as semiconductor material or an optical material, with predefined depth profiles in the depth range of a few nanometers to a plurality of tens of micrometers. Examples of such semiconductor materials include, but are not limited to silicon, silicon carbide, and gallium nitride. Examples of such optical materials include, but are not limited to, LiNbO₃, glass and PMMA.

There is a need to produce depth profiles by ion implantation which have a wider depth distribution than that of a doping concentration peak or defect concentration peak obtainable by monoenergetic ion irradiation or to produce doping or defect depth profiles which cannot be produced by one or a few simple monoenergetic implantations. The doping concentration peak can often be represented approximately by a Gaussian distribution or more precisely by a Pearson distribution. However, there are also deviations from such distributions, especially when so-called channeling effects are present in the crystalline material. Related art methods produce the depth profile using a structured energy filter in which the energy of a monoenergetic ion beam is modified as the monoenergetic ion beam passes through a micro-structured energy filter component. The resulting energy distribution leads to a creation of the depth profile ions in the target material. This is described, for example, in European Patent no. EP 0 014 516 B1. An energy filter for tailoring depth profiles in a semiconductor doping application is know from CSATO CONSTANTIN ET AL (“Energy filter for tailoring depth profiles in semiconductor doping application”, NUCLEAR INSTRUMENTS & METHODS IN PHYSICS RESEARCH. SECTION B: BEAM INTERACTIONS WITH MATERIALS AND ATOMS, vol. 365, pages 182-186, XP029313812, ISSN: 0168-583X, DOI: 10.1016/J.NIMB.2015.07.102). Ion beam irradiation of nanostructures is disclosed BORSCHEL C ET AL (“Ion beam irradiation of nanostructures A 3D Monte Carlo simulation code”, NUCLEAR INSTRUMENTS & METHODS IN PHYSICS RESEARCH. SECTION B: BEAM INTERACTIONS WITH MATERIALS AND ATOMS, vol. 269, no. 19, pages 2133-2138, XP028266956, ISSN: 0168-583X, DOI: 10.1016/J.NIMB.2011.07.004).

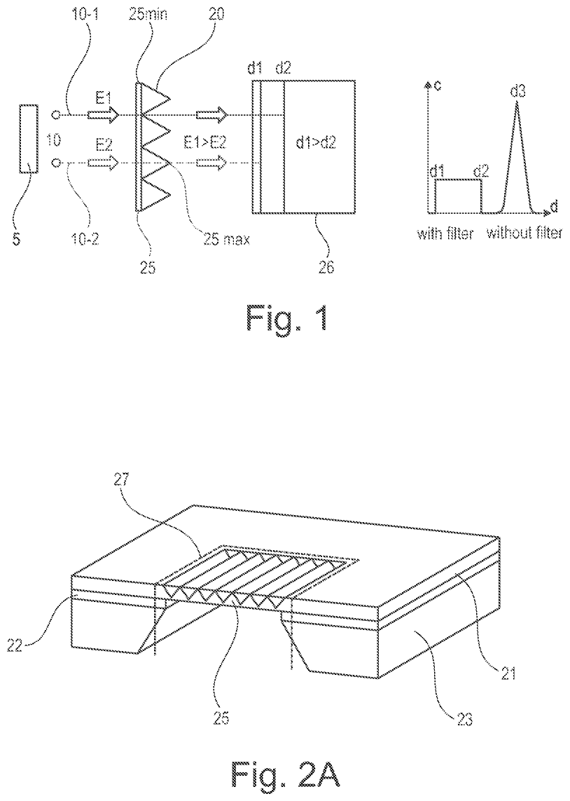

An example of such an ion implantation device 20 is shown in FIG. 1 in which an ion beam 10 impacts a structured energy filter 25. The ion beam source 5 could also be a cyclotron, a rf-linear accelerator, an electrostatic tandem accelerator, or a single-ended-electrostatic accelerator. In other aspects, the energy of the ion beam source 5 is between 0.5 and 3.0 MeV/nucleon or in one aspect between 1.0 and 2.0 MeV/nucleon. In one specific aspect, the ion beam source produces an ion beam 10 with an energy of between 1.3 and 1.7 MeV/nucleon. The total energy of the ion beam 10 is between 1 and 50 MeV, in one aspect, between 4 and 40 MeV, and in a further aspect between 8 and 30 MeV. The frequency of the ion beam 10 could be between 1 Hz and 2 kH, for example between 3 Hz and 500 Hz and, in one aspect, between 7 Hz and 200 Hz. The ion beam 10 could also be a continuous ion beam 10. Examples of the ions in the ion beam 10 include, but are not limited to aluminum, nitrogen, hydrogen, helium, boron, phosphorous, carbon, arsenic, and vanadium.

FIG. 1 shows the basic principle of an energy filter. A monoenergetic ion beam is modified in its energy as the monoenergetic ion beam passes through the micro-structured energy filter component, depending on the point of entry. The resulting energy distribution of the ions leads to a modification of the depth profile of the implanted substance in the substrate matrix.

FIG. 1 shows that the energy filter 25 is made from a membrane having a triangular cross-sectional form on the right-hand side, but this type of cross-sectional form is not limiting of the disclosure and other cross-sectional forms could be used. The upper ion beam 10-1 passes through the energy filter 25 with little reduction in energy because the area 25ₘᵢₙ through which the upper ion beam 10-1 passes through the energy filter 25 is a minimum thickness of the membrane in the energy filter 25. In other words, if the energy of the upper ion beam 10-1 on the left-hand side is E1 then the energy of the upper ion beam 10-1 will have substantially the same value E1 on the right-hand side (with only a small energy loss due stopping power of the membrane which leads to absorption of at least some of the energy of the ion beam 10 in the membrane).

On the other hand, the lower ion beam 10-2 passes through an area 25ₘₐₓ in which the membrane of the energy filter 25 is at its thickest. The energy E2 of the lower ion beam 10-2 on the left-hand side is absorbed substantially by the energy filter 25 and thus the energy of the lower ion beam 10-2 on the right-hand side is reduced and is lower than the energy of the upper ion beam, i.e., E1>E2. The result is that the more energetic upper ion beam 10-1 is able to penetrate to a greater depth in the substrate material 30 than the less energetic lower ion beam 10-2. This results in a differential depth profile in the substrate material 30, which is, for example, part of a semiconductor wafer.

This depth profile is shown on the right-hand side of the FIG. 1. The solid rectangular area shows that the ions penetrate the substrate material to a depth between d1 and d2. However, the horizontal profile shape is a special case, which is, for example, obtained if all energies of the ions are geometrically equally taken into account and if the material of the energy filter and the substrate is the same. The Gaussian curve shows the approximate depth profile without an energy filter 25 and having a maximum value at a depth of d3. It will be appreciated that the depth d3 is larger than the depth d2 since some of the energy of the ion beam 10-1 is absorbed in the energy filter 25.

For typical ion species (N, Al, B, P) in the energy range from 1 MeV up to some tens of MeV (e.g., 40 MeV) it can be observed that low energy ions tend to have a large scattering angle and high energy ions tend to have a small scattering angle. The reason for this different scattering behavior is the energy dependence of the underlying stopping mechanisms. Ions with high kinetic energy preferentially lose their energy by so-called electronic stopping, i.e., excitations of the electron system of the substrate. This usually results in only small directional deviation, i.e., small scattering angles. Ions with low kinetic energy preferentially lose their energy by elastic collisions with the atoms of the substrate, so-called nuclear stopping. This results in large angle scattering.

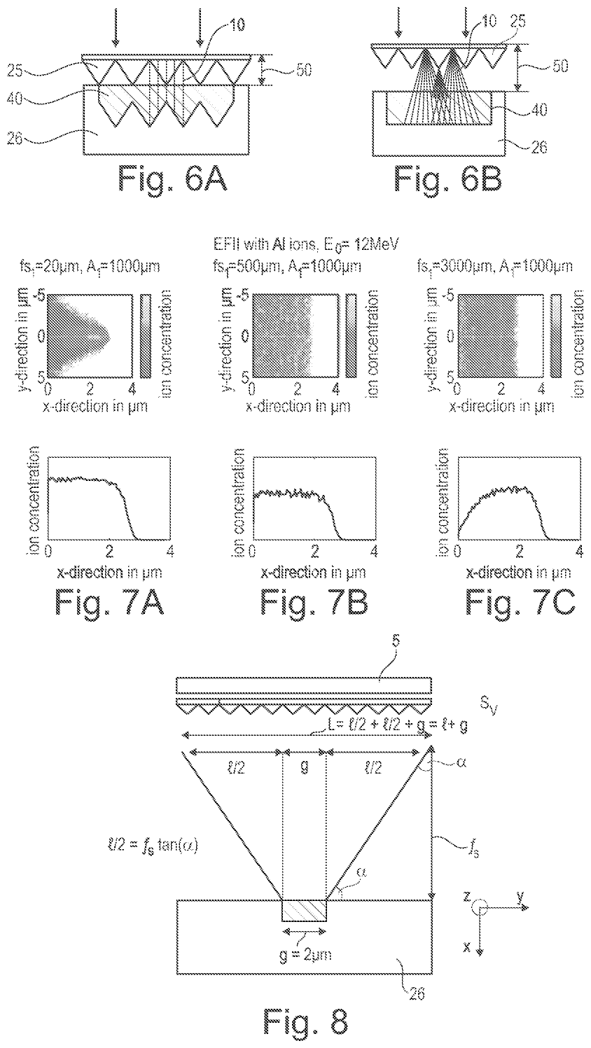

For a static implantation arrangement (i.e., filter and substrate are not moved with respect to each other), which is one aspect for the simulation of doping depth profiles, the distance between filter and substrate plays the decisive role. As can be seen in FIGS. 6A and 6B, if the distance 50 is chosen too small, transfer of the filter structure into the implanted doping depth profile may occur due to the low scattering of high-energy ions. In other words, to avoid this effect, the profiles generated by single filter unit cell or single filter element must overlap sufficiently so that a desired degree of lateral homogenization is achieved.

In summary for a given ion species, a given initial ion energy, a given filter design and a given substrate material and a given filter-substrate distance a certain energy distribution and angular distribution of the filter transmitted ions will be generated.

In the related art there are a number of principles disclosed for the fabrication of the energy filter 25. Typically, the energy filter 25 will be made from bulk material with the surface of the energy filter 25 etched to produce the desired pattern, such as the triangular cross-sectional pattern shown from FIG. 1. In German Patent No. DE 10 2016 106 119 B4 an energy filter was described which was manufactured from layers of materials which had different ion beam energy reduction characteristics. The depth profile resulting from the energy filter depends on the structure of the layers of the material as well as on the structure of the surface.

A further construction principle is shown in the German Patent application DE 10 2019 120 623.5, in which the energy filter comprises spaced micro-structured layers which are connected together by vertical walls.

The maximum power from the ion beam 10 that can be absorbed through the energy filter 25 depends on three factors: the effective cooling mechanism of the energy filter 25, the thermo-mechanical properties of the membrane from which the energy filter 25 is made, as well as the choice of material from which the energy filter 25 is made. In a typical ion implantation process around 50% of the power is absorbed in the energy filter 25, but this can rise to 80% depending on the process conditions and filter geometry.

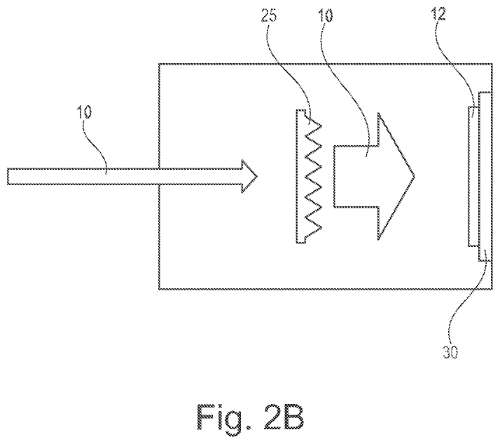

An example of the energy filter is shown in FIG. 2A in which the energy filter 25 is made of a triangular structured membrane mounted in a frame 27. In one non-limiting example, the energy filter 25 can be made from a single piece of material, for example, silicon on insulator which comprises an insulating layer silicon dioxide layer 22 having, for example a thickness of 0.2-1 μm sandwiched between a silicon layer 21 (of typical thickness between 2 and 20 μm, but up to 200 μm) and bulk silicon 23 (around 400 μm thick). The structured membrane is made, for example, from silicon, but could also be made from silicon carbide or another silicon-based or carbon-based material or a ceramic.

In order to optimize the wafer throughput in the ion implantation process for a given ion current for the ion beam 10 and thus use the ion beam 10 efficiently, it is one aspect to only irradiate the membrane of the energy filter 25 and not the frame 27 in which the membrane is held in place. It is likely that at least part of the frame 27 will also be irradiated by the ion beam 10 and thus heat up. It is indeed possible that the frame 27 is completely irradiated. The membrane forming the energy filter 25 is heated up but has a very low thermal conductivity as the membrane is thin (i.e., between 2 μm and 20 μm, but up to 200 μm). The membranes are between 2×2 cm 2 and 35×35 cm² in size and correspond to the size of the target wafers. There is little thermal conduction between the membranes and the frame 27. Thus, the monolithic frame 27 does not contribute to the cooling of the membrane and the only cooling mechanism for the membrane, which is relevant, is the thermal radiation from the membrane.

As shown in FIG. 2B, a substrate holder 30 need not be stationary, but can optionally be provided with a device for moving the substrate 12 in x-y (in the plane perpendicular to the sheet plane). Furthermore, a wafer wheel on which the substrates 12 to be implanted are fixed and which rotates during implantation can also be considered as the substrate holder 30. It is also possible to move the substrate holder 30 in the beam direction (x-direction) of the ion beam 10 with respect to the energy filter 25. Furthermore, the substrate holder 30 may optionally be provided with heating or cooling.

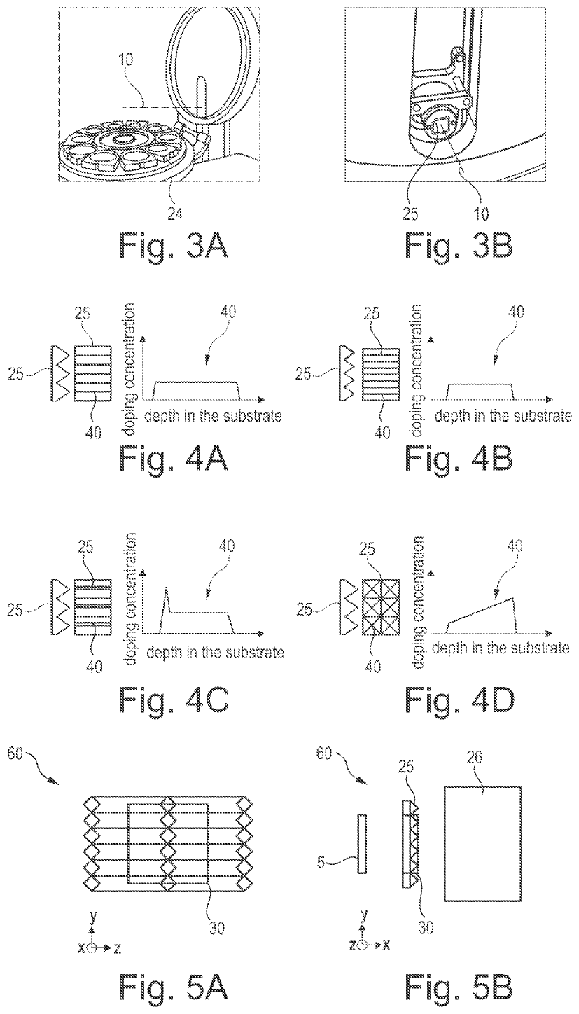

FIGS. 3A and 3B show the typical installation of an energy filter 25 in a system for ion implantation for the purpose of wafer processing. FIG. 3A shows a wafer wheel 24 on which the substrates 26 to be implanted are fixed. During processing/implantation, the wafer wheel 24 is tilted upward by 90° in the direction of the ion beam 10 and set in rotation. The wafer wheel 24 is thus “written” with ions in concentric circles by the ion beam 10. In order to irradiate the entire wafer area, the wafer wheel 24 is moved vertically during processing. In FIG. 3B, a mounted energy filter 25 can be seen in the area of the beam exit. However, the installation of an energy filter 25 in a system for ion implantation for the purpose of wafer processing is not limited to a rotational setup, but also a stationary setup for ion implantation for the purpose of wafer processing is possible, as for example is shown in FIG. 2B.

The layouts or three-dimensional structures of energy filters 25 shown in FIGS. 4A to 4D illustrate the principal possibilities of using energy filters 25 to generate a large number of doping depth profiles 40. In principle, the energy filter profiles can be combined with each other to obtain new energy filter profiles and thus doping depth profiles 40.

FIGS. 4A to 4D show the schematic illustration of different doping depth profiles 40 (doping concentration as a function of depth in the substrate) for differently shaped energy filter microstructures (each shown in a side view and a top view). In FIG. 4A, a triangular prism-shaped structure is shown to produce a rectangular doping depth profile. In FIG. 4B, a smaller triangular prism-shaped structure is shown, producing a less depth-distributed rectangular doping depth profile. In FIG. 4C, a trapezoidal prism-shaped structure is shown that produces a rectangular doping depth profile with a peak at the beginning of the profile. In FIG. 4D, a pyramid-shaped structure is shown that produces a triangular doping depth profile that rises into the depth of the substrate.

In general, one may simulate energy filtered ion implantation. However, the fundamental problem of simulating energy filtered ion implantation lies in the different geometric dimensions of the implantation structure. The energy filter structural elements are typically triangular structures, e.g., made of silicon with a height difference between minimum and maximum membrane thickness of about 1 μm over about 16 μm up to 100 μm. A plurality of such structural elements, arranged side by side, form an energy filter. The dimensions of an energy filter structural element in a direction perpendicular to the ion beam direction are also in the order of a few micrometers to a few 100 μm. For the energy filters used in practice, macroscopic dimensions of the energy filter membrane are required from 2×2 cm, over 17×17 cm up to 40×40 cm. Substrate sizes are also in this range. The distances between the energy filter and the substrate, on the other hand, are typically in the millimeter or centimeter range.

FIG. 5A shows a schematic illustration of a filter unit cell 30 of a filter structure. The energy filters 25 are constructed from single elements or single filter unit cells 30. Each unit cell 30 provides (in the simplest case) the entire energy and angular spectrum of transmitted ions. The characteristic doping depth profiles 40 of an energy-filtered ion implantation (EFII) thus result from the irradiation of a filter unit cell 30. The side-by-side arrangement of the n-unit cells 30 is merely an extension, which is necessary for the irradiation of extended substrates, see FIG. 5A. FIG. 5B shows the cross-sectional view in the y-z plane of a static irradiation situation of the energy filter 25, the ion source 5 and the substrate 26. The structures typically formed with micrometer dimensions in the y-direction become macroscopically extended energy filters, with dimensions up to 40 cm, when arranged in a side-by-side manner. The same is true for the z-direction, as can be also seen in FIG. 5B. The ions are scattered while passing through the energy filter 25. During this process, the ions experience a loss of energy due to geometry and material selection, as well as lateral scattering, resulting in a characteristic energy-angle distribution of the ions after exiting the energy filter 25.

For a static setup according to FIG. 5B, in which the energy filter 25 is arranged plane-parallel to the substrate 26 and at a sufficiently large defined distance from the substrate, a desired degree of lateral homogenization of the energy distribution of the ions in the y-z plane is achieved and thus mapping of the microstructure of the energy filter 25 to the substrate 26 is avoided, i.e., in the sense of a mathematical mapping function. FIG. 6A shows an arrangement in which an energy filter 25 is in contact with the substrate 26, so that a mapping of the energy filter 25 to the doping depth profile 40 takes place. In FIG. 6B an arrangement of the energy filter 25 and the substrate 26 with a “sufficient” distance 50 is shown, so that the doping depth profile 40 is implanted laterally (y-z plane) and homogeneously into the substrate 26 in a plane perpendicular to the ion beam direction of the ion beam 10.

FIGS. 7A to 7C show simulated 1-D (z-y integrated) doping depth profiles 40 as well as 2-D profiles in the x-y plane of the substrate 26 with a filter dimension of 1000 μm×1000 μm. The top plots in FIGS. 7A to 7C show the two-dimensional distribution of the doping concentration in the y-x plane. The corresponding lower representations in FIGS. 7A to 7C show the integral summed-up along both the y-axis and z-axis for each case.

In the following section, this irradiation arrangement of FIG. 5B will now be considered in more detail by means of an example. In particular, the dependence of the resulting energy spectrum on the design of the implantation arrangement (distance filter-substrate) is to be clarified on the basis of the implanted ion concentration as a function of the location in the substrate 26.

Initial situation: filter dimensions of the energy filter 25 are y≈1000 μm, z≈1000 μm with a plurality of unit cells (full triangular structure) arranged in a side-by-side manner, with unit cell dimensions of x=16 μm, y≈11 μm, translation symmetry in z. The implanted ion is aluminum (Al), primary energy 12 MeV, filter material is equal to substrate material, is equal to silicon.

FIG. 7A shows the energy filter 25 and the substrate 26 spaced 20 μm apart. In FIG. 7A, the energy filter 25 and the substrate 26 are at a distance of fs=20 μm from each other. The 2-D map in the x-y plane of the substrate 26 shows a mapping of the microstructure of the energy filter 25 to the substrate 26. The lateral scattering of the ions from neighboring ones of the single cells is not sufficient to achieve a desired degree of lateral homogenization along the y-axis of the doping in the substrate 26, as shown in FIG. 6A.

FIG. 7B shows an energy filter 25 and a substrate 26 spaced 500 μm apart. In FIG. 7B, the energy filter 25 and the substrate 26 are at a distance 50 of fs=500 μm from each other. No transfer of the microstructure of the energy filter 25 to the substrate 26 can be seen. The lateral scattering of ions from neighboring single cells is sufficient to achieve a desired degree of lateral homogenization of the doping in the substrate 26. The filter-substrate spacing was correctly chosen in this case.

FIG. 7C shows the energy filter 25 and the substrate 26 at a distance of 3000 μm from each other. According to FIG. 7C, when the distance between the energy filter 25 and the substrate 26 is further increased, de-homogenization of the energy distribution of the ions in the y-z plane occurs, resulting in a gradient in the depth doping depth profile summed along the y-axis. This de-homogenization of the energy spectrum of the ions is due to the large distance between the energy filter 25 and the substrate 26, as well as the dimensions of the ion source and the energy filter 25. Both the scattering angle of the scattered ions with large scattering angle and the large filter-substrate distance result in that some of the strongly scattered ions will no longer hit the substrate 25 and are scattered past the substrate 25. The ions scattered in this way no longer hit the substrate 25 and are therefore “lost”.

In real energy-filtered irradiation, it is one aspect to achieve a laterally homogeneous concentration and energy distribution of the ions analogous to the situation shown in FIG. 7B. The desired degree of lateral homogenization of the doping depth profile as well as the preservation of the full characteristic energy spectrum is realized in practice by dynamic implantation. Here, the microstructure mapping, independent of the distance, is avoided by a relative movement from the substrate 26 to the energy filter 25. Furthermore, in practice, the loss of ions at the edge of the wafer substrate 26 is avoided by over-scanning the filtered ion beam beyond the edges of the substrate 26.

For the simulation of energy-filtered ion implantation, a static arrangement is assumed. To achieve a desired degree of lateral homogenization and avoid particle loss, the boundary condition is that the resulting energy spectrum of the simulated energy filter must be independent of the spatial coordinates y-z on the wafer. In other words, the full energy-angle spectrum of a unit cell must be found on any y-z position on the wafer.

Ion implantation is a process “composed” of a large number of individual events. One needs a large number of single ions (typically 1E12 cm-2-1E15 cm-2) in order to form typical distributions in the substrate due to statistical scattering processes. The use of Monte Carlo techniques is therefore widespread in the field of ion implantation.

Therefore, simulation methods can support or shorten development processes or facilitate the accurate design and dimensioning of processes and products. In order to be able to carry out a reasonable simulation in terms of time and cost with sufficient statistics, a method must therefore be used which takes into account the different size ratios and in this way drastically reduces the complexity and the computational effort for the simulation without loss of accuracy.

The typical dimensions of interesting simulation areas for ion implantation process simulation in semiconductor technology are perpendicular to the ion beam in the size range of a plurality of micrometers up to a plurality of millimeters or even centimeters and parallel to the ion beam (depth profile) in the range of a plurality of micrometers up to 100 micrometers. The typical resolution requirement in all directions is at least 5 or 10 nanometers. To achieve the required spatial resolution, these areas must be subdivided into a fine grid in the nanometer range and simulated with a correspondingly high number of events to resolve relevant characteristics with high event density.

It is an object of the present disclosure to provide a method, which allows the simulation of doping depth profiles of energy filtered ion beams by means of a so-called “Monte Carlo” algorithm. In particular to provide a method for complex ion implantation processes, such as the EFII process, to be efficiently simulated using the Monte Carlo method in order to be able to reproduce the real physical process and its effects in the substrate as accurately as possible and without artifacts.

By implementing the ion implantation arrangement in a Monte Carlo simulation environment, the complex structure of such an array implies a high workload for the implementation of the involved structures. In general, the widely varying dimensions of the microscopic filter structure compared to the filter-substrate spacing results in a poor ratio of total simulation volume S_{V}, e.g., shown in FIG. 8, to the “interesting” simulation area g. The demand for high grid and event density of the simulation area causes a high total number of simulation events in the total simulation volume S_{V}, which can only be simulated with cost-intensive computing technology and high simulation durations.

It is an object of the present disclosure to provide a method for embedding the simulation of energy-filtered ion implantation into the tool landscape for technology simulation of semiconductor electronic devices (TCAD).

It is an object of the present disclosure to provide a computer-implemented method to significantly improve the efficiency of the Monte Carlo simulation of an energy-filtered implantation process, i.e., to reduce the effort for the implementation of the model, to reduce the complexity of the computer simulation and ultimately to reduce the computing time or to reduce the requirements on the performance of the computer hardware. With respect to the geometric simulation model, the present disclosure improves the ratio of the total simulation volume S_{V} to the simulation area g. The present disclosure enables the reduction of the number of simulation events while maintaining a high event density in the simulation area g. As a result, simulation time can be saved.

Therefore, there is a need to improve a method for simulating energy filtered ion implantation.

### SUMMARY

According to a first aspect the disclosure a computer-implemented method for the simulation of an energy-filtered ion implantation (EFII), comprising the steps of: determining at least one part of an energy filter; determining at least one part of an ion beam source; determining a simulation area in a substrate; Implementing the determined at least one part of the energy filter, the determined at least one part of the ion beam source, the determined simulation area in the substrate; determining a minimum distance between the implemented at least one part of the energy filter and the implemented substrate for enabling a desired degree of a lateral homogenization of the energy distribution in a doping depth profile of the implemented substrate; determining a maximum expected scattering angle of the energy filter by simulating an energy-angle spectrum for the energy filter; and defining a total simulation volume. Thereby, it is possible to provide a simulation volume Sᵥ as small as possible and to provide a simulation volume Sᵥ in a simplified manner. A static filter-substrate arrangement can be further provided independent of a static or dynamic real implantation setup. Therefore, the method enables the simplification of the geometry to be implemented by considering the energy-angle distribution and the associated geometric constraints.

In one aspect of the method, the minimum distance between the energy filter and the substrate is between 100 μm and 1000 μm for the simulation of the EFII process of Al-ions with a kinetic primary energy of 12 MeV.

In another aspect of the method, the energy filter by the determined maximum expected scattering angle defines the number of filter unit cells arranged next to each other.

In another aspect of the method, the simulation area to be analyzed in the substrate is between 1 μm to 500 μm in either direction.

According to a second aspect of the disclosure a computer-implemented method for the simulation of an energy-filtered ion implantation (EFII), comprising the steps of: approximating an energy filter in at least one base element; selecting at least one of the at least one base element such that the desired geometry and material composition of the energy filter to be simulated can be assembled from the selected base elements. Determining the energy-angle spectrum for the selected at least one base element; determining a virtual ion beam source based on the determined energy-angle spectrum of the selected at least one base element; and simulating the implantation effects in a simulation area in a substrate. Thereby, the more complex simulation task can be separated into the definition of a virtual ion beam source (i.e., EFIIS-source), and the subsequent simulation of ion implantation effects for arbitrary substrates. The method enables the simulation task in a sequence of process steps in conjunction with simulations that make it possible to reduce the overall simulation volume and thus increase efficiency of carrying out the simulation. Therefore, the method enables even the simulation of more complex energy filters. This results from the improved ratio of total simulation volume Sᵥ to simulation area g, where here the simulation volumes are independent of each other in the steps of the determination of the virtual ion beam characteristic, and the simulation of simulation area g by means of the previously defined virtual ion beam. This also allows a better simulation efficiency, in which the dimensions of the energy filter and the simulation area are very different. Furthermore, the event densities and grid densities of the two process steps of the method can be defined independently of each other, which allows the simulation to be optimized according to the requirements.

In one aspect of the method, the at least one base element is one of at least one part of at least one energy filter element, a filter unit cell of the energy filter, or a set of discrete energy filters.

In one aspect of the method, the energy filter is triangular-shaped, pyramid-shaped, inverted pyramid-shaped, or free-form shaped.

In another aspect of the method, the filter unit cell of the energy filter is composed of a plurality of base elements of different geometry, different material compositions of different layer structures.

In one aspect of the method, the implantation effects are one of defect generation, doping profile, masking effects.

In another aspect of the method, new filter geometry, new filter material selection, new layer composition of the energy filter, new primary ion, new primary ion energy, new primary ion implantation angle and a new virtual ion beam source are determined.

In one aspect of the method, the method comprises the step of storing the least one base element in a data base.

In one aspect of the method, the method comprises the step of storing the virtual ion beam source in a data base.

In another aspect of the method, the method comprises the step of parametric analyzing a masking structure on the substrate for optimization of the masking thickness, material composition, and masking layout and for optimizing the 3D-doping profile in the substrate, which is influenced by the masking structure. The mask structure can significantly influence the 3D-doping profile through its composition, thickness (partial transparency) and the angle of its “slopes” (partial implantation at a flat angle). These influences can be analyzed very well with the method according to the present disclosure or the doping profiles and the masks can be optimized.

In one aspect of the method, the optimization of the masking structure and/or 3D-doping profile on the substrate is carried out using a Monte Carlo simulation. The mask structure can significantly influence the 3D-doping profile through its composition, thickness (partial transparency) and the angle of its “slopes” (partial implantation at a flat angle). These influences can be analyzed very well with the method according to the present disclosure or the doping profiles and the masks can be optimized.

### DESCRIPTION

The disclosure will now be described on the basis of figures. It will be understood that the aspects of the disclosure described in the figures are only examples and do not limit the protective scope of the claims in any way. The disclosure is defined by the claims and their equivalents. It will be understood that features of one aspect of the disclosure can be combined with a feature of a different aspect of the disclosure. This disclosure becomes more obvious when reading the following detailed descriptions of some examples as part of the disclosure under consideration of the enclosed drawings, in which:

FIG. 1 shows the principle of the ion implantation device with an energy filter as disclosed in the related art.

FIG. 2A shows a structure of the ion implantation device with the energy filter.

FIG. 2B shows the typical installation of an energy filter in a system for ion implantation for the purpose of wafer processing, with movable substrate.

FIGS. 3A and 3B show the typical installation of an energy filter in a system for ion implantation for the purpose of wafer processing.

FIGS. 4A to 4D show three-dimensional structures of filters illustrating the principal possibilities of using energy filters to generate a large number of doping depth profiles.

FIG. 5A shows the schematic illustration of a unit cell of a filter structure.

FIG. 5B shows the cross-sectional view of FIG. 5A in the y-z plane of a static irradiation situation of an energy filter, ion source and a substrate.

FIG. 6A shows an arrangement such that an energy filter is in contact with a substrate.

FIG. 6B shows an arrangement of an energy filter and a substrate with “sufficient” distance.

FIGS. 7A to 7C show a filter and substrate spaced 20 μm, 500 μm, and 3000 μm apart.

FIG. 8 shows a schematic illustration of a static simulation model of an energy-filtered ion implantation EFII according to the first aspect of the present disclosure.

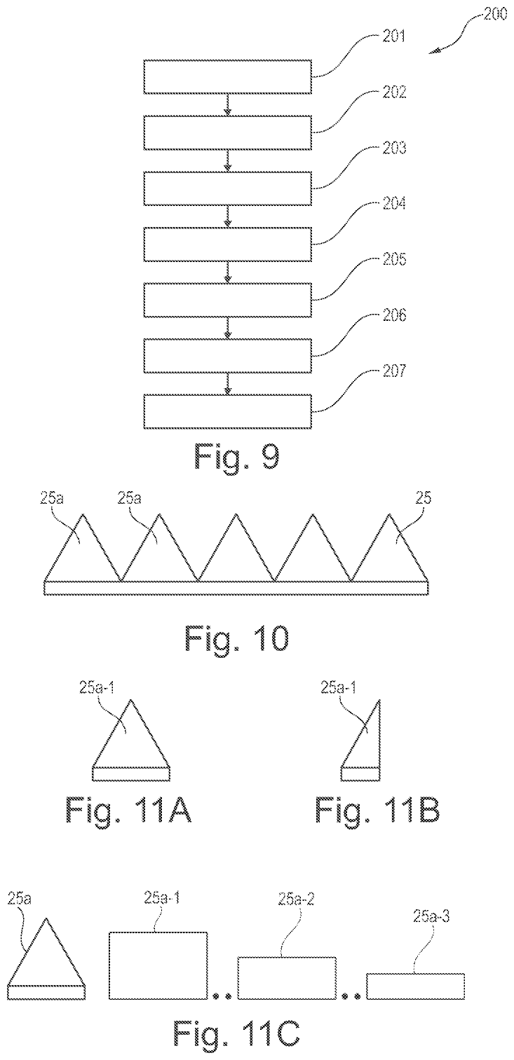

FIG. 9 shows a flowchart of the method according to the first aspect of the present disclosure for the simulation of the energy-filtered ion implantation (EFII).

FIG. 10 shows a schematic side view of an energy filter to be simulated.

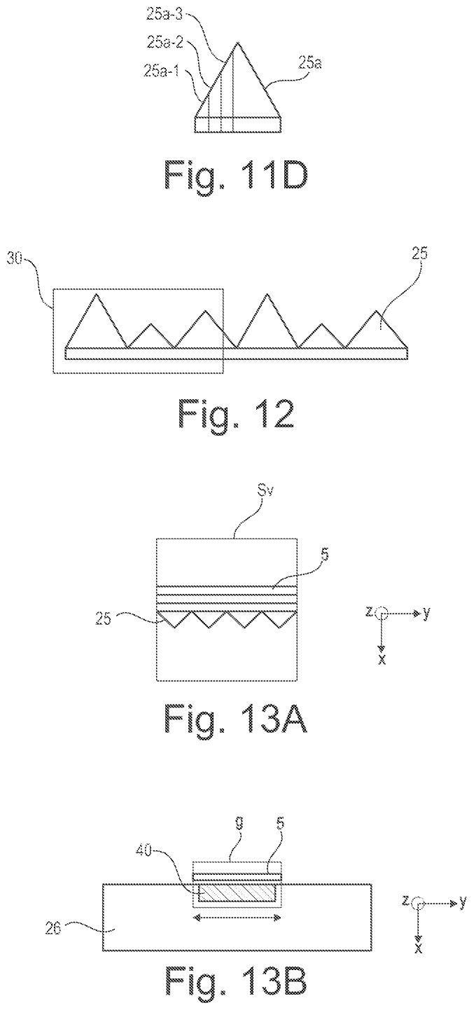

FIGS. 11A to 11D show a schematic side views of base elements approximated from the energy filter to be simulated.

FIG. 12 shows a schematic side view of a complex energy filter to be simulated with a filter unit cell.

FIGS. 13A and 13B show simulation models of an energy-filtered ion implantation EFII according to the second aspect of the present disclosure.

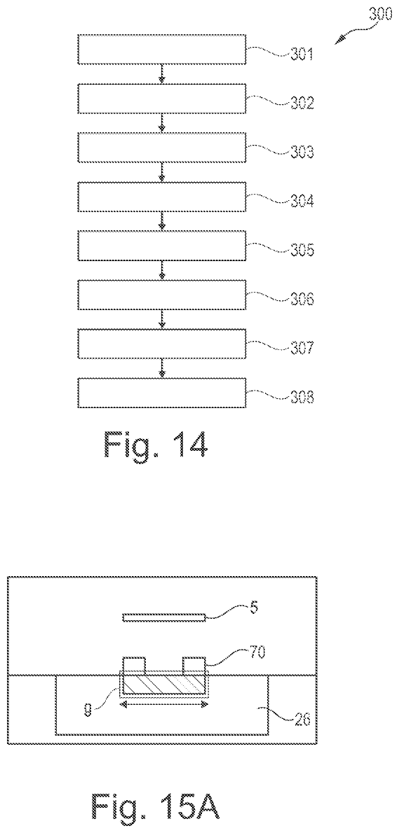

FIG. 14 shows a flowchart of the method according to the second aspect of the present disclosure for the simulation of the energy-filtered ion implantation (EFII).

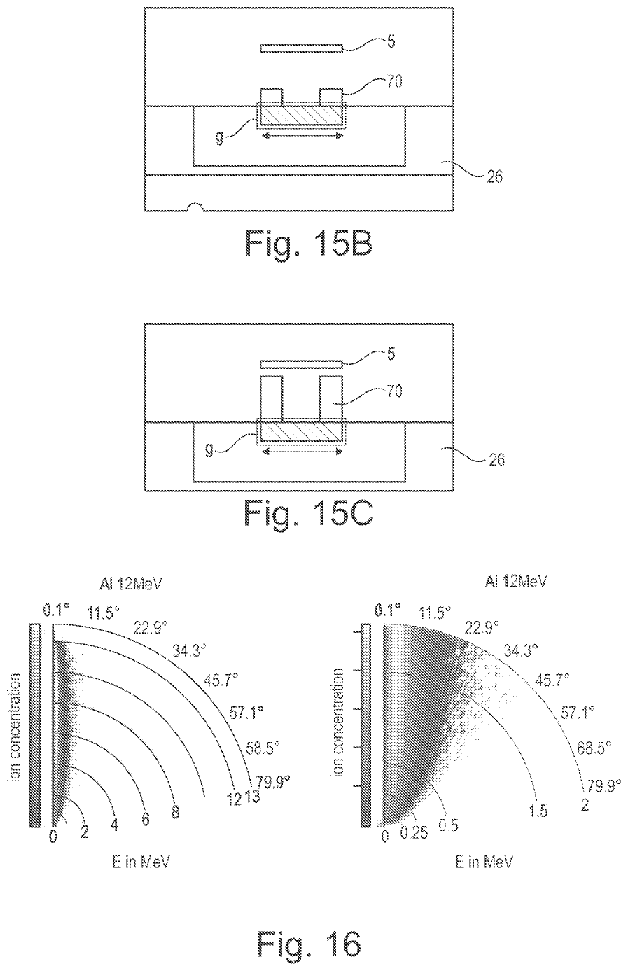

FIGS. 15A to 15C show an optimized parametric simulation to another aspect of the present disclosure.

FIG. 16 shows the energy-angle distribution for EFII of an Al ion with initial energy of 12 MeV and typical filter dimensions, wherein the maximum scattering angle α is about 70°.

### DETAILED DESCRIPTION

FIG. 8 shows a schematic illustration of a static simulation model of an energy-filtered ion implantation (EFII) according to the first aspect of the present disclosure. The energy-angle distribution characteristics of the static simulation model of the EFII correspond to the real implantation conditions as well as representation of the required geometric boundary conditions for correct reproduction of the energy-angle spectrum. FIG. 8 shows the dimensioning of the ion source resulting from the area-wide scanning process of the ion beam during implantation. The EFII process can be simulated into a Monte Carlo simulation environment. As can be seen in FIG. 8, the filter-substrate distance 50 (fs) has to be dimensioned at least with the distance 50 in which the scattering of the ions leads to a desired degree of a lateral homogenization of the energy distribution and in one aspect implementation no structure transfer of the microstructure of the energy filter into the substrate 26 is visible. For a simulation of the EFII process of Al ions with a kinetic primary energy of 12 MeV, this minimum distance 50 is fs=500 μm according to FIG. 7B.

The maximum expected scattering angle α of a filter unit cell 30 is to be determined. For this purpose, the energy-angle spectrum for a given filter unit cell 30 is simulated and the maximum scattering angle α (which is still experienced by a relevant number of ions) is determined. In particular, with a high number of simulated ions, there will always be a few ions that have scattering angles close to 90°. Therefore, the angle α could be defined in a way that the angle α includes the relevant part of the scattered ions, i.e., not considering the scattered ions with a scattering angle larger than the angle α, which in total make up less than 1% or 2% of the total number of ions. This lowers the accuracy but simplifies the simulation. As shown in FIG. 8, this maximum angle α is used to calculate the total width of the filter model, i.e., how many filter elementary cells must be arranged next to each other in a side-by-side manner. To guarantee that the full angle spectrum of the ions will hit the simulation area g, the characteristic energy filter implantation profile will be generated in the simulation area g. For the simulation of the EFII process of Al ions with a primary kinetic energy of 12 MeV and a distance 50 between the energy filter 25 and the substrate 26 of fs=500 μm, the maximum scattering angle α is about 70° degrees, as can be seen in FIG. 16. FIG. 8 shows the width of the energy filter 25 and the ion source 5. The area to be analyzed (i.e., simulation area g) in the substrate 26 is given by g=2 μm. The required total width of ion beam source 5 and the energy filter 25 is thus L=2749 μm. The area to be analyzed (i.e., simulation area g) in the substrate 26 can also be between 1 μm and 500 μm.

The total dimension of the simulation is calculated with the formula L=l+g, wherein the width l of the ion beam source 5 and the energy filter 25 is calculated with, the following formula:

½=fₛ tan(α)

wherein α=the maximum scattering angle, and fₛ=distance 50 between the energy filter 25 and the substrate 26.

FIG. 9 shows a flowchart of the computer-implemented method 200 according to the first aspect of the present disclosure for the simulation of the energy-filtered ion implantation (EFII). The method 200 for the simulation of an energy-filtered ion implantation (EFII) comprising the steps of: determining 201 at least one part of an energy filter 25; determining 202 at least one part of an ion beam source 5; determining 203 a simulation area g in a substrate 26; implementing 204 the determined at least one part of the energy filter 25, the determined at least one part of the ion beam source 5, the determined simulation area g in the substrate 26. The simulation environment is, for example, a Monte Carlo simulation. The method 200 further comprises the step of determining 205 a minimum distance 50 (fs) between the implemented at least one part of the energy filter 25 and the implemented substrate 26 for enabling a desired degree of a lateral homogenization of the energy distribution in a doping depth profile 40 of the implemented substrate 26; determining 206 the maximum expected scattering angle α of the energy filter 25 by simulating an energy-angle spectrum for the energy filter 25; and defining 207 the total simulation volume Sᵥ (see dotted line in FIG. 8).

For example, the method 200 further requires that the minimum distance 50 (fs) between the energy filter 25 and the substrate 26 is between 100 μm and 1000 μm for the simulation of the EFII process of Al-ions with a kinetic primary energy of 12 MeV. The method 200 further comprises that the maximum expected scattering angle α of the filter unit cell 30 is 70° for the simulation of the EFII process of Al-ions with a kinetic primary energy of 12 MeV and the minimum distance 50 of 500 μm. The method 200 further comprises that the simulation area g in the substrate 26 is in one-dimension 2 μm. The method 200 further comprises that the total width l of the energy filter 25 by the determined maximum expected scattering angle α is the number of filter unit cells arranged next to each other. For example, the minimum distance 50 (fs) between the energy filter 25 and the substrate 26 can also be 0 μm (no homogenization) over 100 μm up to 1000 μm or up to some millimeters (full homogenization). For light ions (hydrogen) and very high energies and large filter structures (e.g., 100 μm thickness) larger distances 50 than 1000 μm will be necessary.

FIG. 10 shows a schematic side view of the energy filter to be simulated. The computer-implemented method 300 according to the second aspect of the present disclosure comprises a first process step of selecting one or more base elements 25a-1, 25a-2, . . . 25a-n. The base elements 25a-1, 25a-2, . . . 25a-n are for example energy filter elements 25a (shown in FIG. 11A), filter unit cells 30 or a set of discrete energy filter elements 25a (shown in FIG. 11C). The selection is made in such a way that the desired geometry and material composition of the overall energy filter 25 to be simulated can be assembled from these base elements. FIGS. 11A to 11D show examples illustrating the possibilities of selecting or defining base elements 25a-1, 25a-2, . . . 25a-n. FIGS. 11A to 11D show a schematic side views of the base elements 25a-1, 25a-2, . . . 25a-n approximated from the energy filter 25 to be simulated. FIG. 12 shows a schematic side view of a complex energy filter to be simulated with a filter unit cell 30. As shown in FIG. 11D, the triangular structure of the energy filter elements 25a can be approximated by n-adjacent discrete filter membrane pieces 25a-1, 25a-2, 25a-3, . . . 25a-n.

FIGS. 13A to 13B show a simulation model of an energy-filtered ion implantation EFII with approximated geometric conditions according to the second aspect of the present disclosure. FIGS. 13A and 13B show the schematic representation of the geometric simulation models of the method 300 as well as the sequence of the simulations. However, the present disclosure is not limited to a sequence of the simulations but could also be a single simulation.

As shown in FIG. 14, the method 300 according to the second aspect of the present disclosure for the simulation of the energy-filtered ion implantation (EFII) with approximated geometric conditions, comprises as a first process step the steps of: approximating 301 the energy filter 25 in at least one base element 25a-1, 25a-2, . . . , 25a-n; selecting 302 at least one of the at least one base element 25a-1, 25a-2, . . . , 25a-n such that the desired geometry and material composition of the energy filter 25 to be simulated can be assembled from the selected base elements 25a-1, 25a-2, . . . , 25a-n; and determining 303 the energy-angle spectrum for the selected at least one base element 25a-1, 25a-2, . . . , 25a-n. The at least one base element 25a-1, 25a-2, . . . , 25a-n is one of at least one part of at least one energy filter element 25a, a filter unit cell 30 of the energy filter 25, or a set of discrete energy filters 25. The energy filter 25 can be, for example, triangular-shaped, pyramid-shaped, inverted pyramid-shaped, or free-form shaped. The filter unit cell 30 of the energy filter 25 is composed of a plurality of base elements of different geometry, different material compositions of different layer structures.

After the first process step, in the next step, the relevant properties of the ion beam characteristics (energy and angle, y-z coordinates dependency of energy and angle of the ions), which act on the simulation area g due to the filter properties and the properties of the primary ions, are calculated for all of the selected basic elements 25a-1, 25a-2, . . . , 25a-n. The method 300 according to the present disclosure is not limited to triangular-shaped ones of the energy filters 25. Rather, pyramidal, inverted pyramidal, or more generally free-form structures for the energy filters 25 can also be simulated using the method 300. For example, the energy filter 25 or filter unit cell 30 can be composed of a plurality of base elements 25a-1, 25a-2, . . . , 25a-n of different geometry, different material composition or different layer structure. Tilting of the energy filter 25 or mirroring about an axis perpendicular to the ion beam 10 is also possible.

As shown in FIG. 14, after the first process step, the method 300 for the simulation of the energy-filtered ion implantation (EFII), comprising as a second process step the steps of: determining 304 a virtual ion beam source 5 based on the determined energy-angle spectrum and defining for a EFII desired degree of lateral (y-z coordinates) homogenization of distribution of energy and angles of the ions of the selected at least one base element 25a-1, 25a-2, 25a-3, . . . , 25a-n. In one further aspect, the energy-angle distribution of a single energy filter 25 is determined, where the energy filter 25 can be a “simple” elementary cell, as in FIG. 10, or a “complex” elementary cell, as in FIG. 12. The determination of the energy-angle distribution can be done by a plurality of steps using different methods. Simulation methods (simulation of one or more basic elements), analytical methods as well as experimentally obtained results or combinations of such methods are conceivable.

The method 300 for the simulation of the energy-filtered ion implantation (EFII), comprising as the second process step also the step of simulating 305 the implantation effects in the simulation area g in the substrate 26. In the next step, a virtual ion beam source 5 with an energy-angle characteristic is defined, which is composed of the ion beam characteristics of the base elements 25a-1, 25a-2, 25a-3, . . . , 25a-n selected in the first process step of method 300. Thus, this composite virtual ion beam source 5 corresponds exactly (or approximates) the ion beam characteristics (energy and angle distribution) of the overall energy filter 25 to be simulated. As shown in FIGS. 13A and 13B, this virtual ion source 5, also referred as EFIIS source 5, is used to simulate the implantation effects (defect generation, doping profile, masking effects) in the target substrate 26 under investigation (simulation region g).

Therefore, for each new filter geometry, new filter material selection, new layer composition of the energy filter 25, new primary ion, new primary ion energy, new primary ion implantation angle (i.e., distribution) a new virtual ion beam source 5, i.e., EFIIS source 5, is defined. The ion beam source 5, i.e., EFIIS source 5, can be used to simulate and analyze the effects of ion implantation on any substrate 26. The ion beam source 5, i.e., EFIIS source 5, and also the underlying base elements 25a-1, 25a-2, 25a-3, . . . , 25a-n of the energy filters 25 can be stored in databases (not shown) in the first process step of the method 300. Furthermore, it is possible to successively improve the virtual ion beam source 5, i.e., EFIIS source 5, by matching simulation results with experimental results.

As shown in FIG. 14, the method 300 further comprises that the implantation effects are one of defect generation, doping profile, masking effects. The method 300 further comprises that for a new filter geometry, a new filter material selection, a new layer composition of the energy filter 25, a new primary ion, a new primary ion energy, a new primary ion implantation angle, and a new virtual ion beam source 5 is determined. The method 300 further comprises the step of storing 306 the least one base element 25a-1, 25a-2, 25a-3, . . . , 25a-n in a data base (not shown). The method 300 further comprises the step of storing 307 the virtual ion beam source 5 in a data base (not shown).

Further significant advantages result from a systematic investigation of a simulation area g, with variation of a geometry parameter in the simulation area. This is shown, for example, in FIGS. 15A to 15C, which illustrates a typical simulation investigation when varying the masking thickness on the substrate 26. The aim of this investigation is to determine the necessary masking thickness, geometrical shape, material composition and layout and for investigating/optimizing the 3D dopant profile in the substrate for a fixed energy filter 25 and fixed primary ion properties, i.e., for a given ion beam source, i.e., EFIIS source, using a Monte Carlo simulation. By separating the first process step and the second process step according to method 300 as well as the constant EFII parameters, the first process step only needs to be performed once and second process step for each variation of the masking thickness. This saving of the process step for each follow-up investigation of the second process step is reflected in a saving of simulation time. Library solutions are also conceivable, in which the ion beam characteristics are stored with defined parameters for follow-up simulations in the Monte Carlo simulation. These simulation optimizations have a positive effect on simulation durations, hardware, resources, and energy consumption.

As shown in FIG. 14, the method 300 further comprises the step of parametric analyzing 308 a masking structure 70 on the substrate 26 for detecting the masking thickness geometrical shape, material composition and layout and for investigating/optimizing the 3D dopant profile in the substrate, as shown in FIGS. 15A to 15C. As shown in FIG. 14, the method 300 further comprises that the analyzing 308 of the masking structure 70 on the substrate 26 is carried out by using a Monte Carlo simulation.

As shown in FIG. 16, the energy-angle distribution for EFII of an Al ion with initial energy (E) of 12 MeV and typical filter dimensions, wherein the maximum scattering angle α is about 70°.

1. A computer-implemented method for the simulation of an energy-filtered ion implantation, comprising:
determining at least one part of an energy filter;
determining at least one part of an ion beam source;
determining a simulation area in a substrate;
implementing the determined at least one part of the energy filter, the determined at least one part of the ion beam source, the determined simulation area in the substrate;
determining a minimum distance between the implemented at least one part of the energy filter and the implemented substrate for enabling a desired degree of a lateral homogenization of the energy distribution in a doping depth profile of the implemented substrate;
determining a maximum expected scattering angle of the energy filter by simulating an energy-angle spectrum for the energy filter; and
defining a total simulation volume.

2. The method of claim 1, wherein the minimum distance between the energy filter and the substrate is between 100 μm and 1000 μm for the simulation of the EFII process of Al-ions with a kinetic primary energy of 12 MeV.

3. The method of claim 1, wherein the energy filter is constructed from single filter unit cells, wherein the single filter unit cells are composed of a plurality of base elements of different geometry, different material composition or different layer structure, and wherein the total width of the energy filter by the determined maximum expected scattering angle is the number of the filter unit cells arranged next to each other.

4. The method of claim 1, wherein either direction of the simulation area to be analyzed in the substrate is between 1 μm and 500 μm when viewed perpendicular to an ion beam.

5. A computer-implemented method for the simulation of an energy-filtered ion implantation comprising the steps of:
approximating an energy filter in at least one base element;
selecting at least one of the at least one base element such that the desired geometry and material composition of the energy filter to be simulated can be assembled from the selected base elements;
determining the energy-angle spectrum for the selected at least one base element;
determining a virtual ion beam source based on the determined energy-angle spectrum of the selected at least one base element; and
simulating implantation effects in a simulation area in a substrate.

6. The method of claim 5, wherein the at least one base element is one of at least one part of at least one energy filter element, a filter unit cell of the energy filter, or a set of discrete energy filters.

7. The method of claim 5, wherein the energy filter is triangular-shaped, pyramid-shaped, inverted pyramid-shaped, or free-form shaped.

8. The method of claim 6, wherein the filter unit cell of the energy filter is composed of a plurality of base elements of different geometry, different material compositions of different layer structures.

9. The method of claim 5, wherein the implantation effects comprise at least one of defect generation, doping profile, masking effects.

10. The method of claim 5, wherein for a new filter geometry, a new filter material selection, a new layer composition of the energy filter, a new primary ion, a new primary ion energy, a new primary ion implantation angle and a new virtual ion beam source are determined.

11. The method of claim 5, further comprising the step of storing the least one base element in a data base.

12. The method of claim 5, further comprising the step of storing the virtual ion beam source in a data base.

13. The method of claim 5, further comprising the step of parametric analyzing a masking structure on the substrate for optimization of the masking thickness, material composition and masking layout and for optimizing the 3D dopant profile in the substrate.

14. The method of claim 13, wherein the analyzing of the masking structure on the substrate for optimization of the masking thickness, material composition and masking layout and for optimizing the 3D dopant profile in the substrate is using a Monte Carlo simulation.

15. A computer program, comprising instructions, which when executed out by a computer, causing the computer to carry out the method of claim 1.
